(19) United States
(12) Patent Application Publication
(10) Pub. No.: US 2015/0072903 A1
(43) Pub. Date: Mar. 12, 2015

(54) OIL DRILLING AUXILIARY DISPERSION

(71) Applicant: KUREHA CORPORATION, Tokyo (JP)

(72) Inventors: Shunsuke ABE, Tokyo (JP); Nanako SAIGUSA, Tokyo (JP); Masahiro YAMAZAKI, Tokyo (JP); Hiroyuki SATO, Tokyo (JP)

(21) Appl. No.: 14/539,266

(22) Filed: Nov. 12, 2014

Related U.S. Application Data
(62) Division of application No. 13/878,606, filed on Jun. 13, 2013, now abandoned.

(30) Foreign Application Priority Data
Oct. 14, 2010 (JP) 2010-231954

(51) Int. Cl. C09K 8/588

(52) U.S. Cl. CPC C09K 8/588
USPC 507/117

(57) ABSTRACT

A dispersion liquid for supporting oil drilling, including: an aqueous medium and a particulate solid polyglycolic acid resin dispersed in the aqueous medium; wherein the particulate polyglycolic acid resin has a weight-average molecular weight of at least 70,000 and at most 500,000, and exhibits weight retentivities in water at 80° C. of at least 85% after 12 hours, at most 80% after 72 hours, and at most 45% after 168 hours. The particulate solid polyglycolic acid resin included in the above-mentioned dispersion liquid for supporting oil drilling, functions as a fluidity control material exhibiting ideal degradation charateristics in the drilling operation for expansion of oil production capacity, demanded for suppressing the liquid permeability in the early stage and recovery of the liquid permeability after completion of the operation of the formation around the oil well.

### TECHNICAL FIELD

The present invention relates to a dispersion liquid for supporting oil drilling for recovery of hydrocarbons, including oil and gas, or a step of expansion in amount of production fluid recovery, at relatively low temperatures (e.g., at 40-80° C.).

### BACKGROUND ART

For recovery from the underground of hydrocarbons including oil and gas (representatively called “oil” hereafter), oil wells, gas wells, etc. (sometimes representatively called “oil well” hereafter) are bored. There are included a step of drilling a vertical well while recycling muddy water, and a subsequent work of injecting a fracturing fluid into a stratum to produce a crack for expanding the quantity of production (i.e., fracturing). Although it is desirable by nature for the geological stratum (formation) around oil well to exhibit high liquid permeability from a viewpoint of the promotion of inflow of oil to the oil well through the formation, it is sometimes required to suppresses temporarily the fluid permeation into the formation from a viewpoint of working efficiency in drilling work and fracturing. This is required, for example, for preventing the escape of work water, such as muddy water, through the wall of an already formed oil well. Suppression of liquid permeability is mainly achieved by filler materials (or agents), such as inorganic particles, such as a gravel and calcium carbonate, or gel-like organic matters, such as or guar gum (guar), mixed in work water etc., and recovery of suppressed liquid permeability is achieved by dissolution of the inorganic filler with an acid etc., or the use of an agent for decomposing a gel-like organic matter (called a gel breaker). Generally such materials are inclusively called fluid loss (control) additives or diverting agents. On the other hand, in relatively recent years, various proposals of using aliphatic polyester having hydrolyzability, such as polyglycolic acid and polylactic acid, alone or together with dissolution accelerators, such as an alkali source, as a fluid control material (and/or gel breaker), have been made (Patent document 1-4, etc.). This is because these aliphatic polyesters cause relatively prompt hydrolysis at least at temperatures of 80° C. or more acquired by co-use of steam (under pressure), to smoothly perform the recovery of suppressed liquid permeability, which is particularly difficult among the fluid controls, comparatively well. Particularly, polyglycolic acid resins having molecular weights of oligomer ranges, such as 200-4000 (Patent document 1) or 200-600 (Patent documents 2 and 4), have been proposed as fluid control materials having a satisfactory hydrolysis rate even at low temperatures, such as, 40-80° C.

### PRIOR ART DOCUMENTS

### Patent Documents

[Patent document 1] U.S. Pat. No. 4,715,967

[Patent document 2] U.S. Pat. No. 4,986,353

[Patent document 3] U.S. Pat. No. 7,265,079

[Patent document 4] U.S. Pat. No. 7,066,260.

### SUMMARY OF INVENTION

### Problems to be Solved by the Invention

In view of the above-mentioned prior-art, a principal object of the present invention is to provide a dispersion liquid for supporting oil drilling containing a fluid control material which is suitable for use at low temperatures and flexibly used than conventional materials.

### Means for Solving the Problem

The dispersion liquid for supporting oil drilling of the present invention is developed for achievement of the above-mentioned object, and comprises: an aqueous medium and a particulate solid polyglycolic acid resin dispersed in the aqueous medium, wherein the particulate polyglycolic acid resin has a weight-average molecular weight of at least 70,000 and at most 500,000, and exhibits weight retentivities in water at 80° C. of at least 85% after 12 hours, at most 80% after 72 hours, and at most 45% after 168 hours.

According to the finding by the present inventors, the above-mentioned polyglycolic acid resins having molecular weights of oligomer ranges may be suitably used for well drilling and fracturing work which are done for a relatively short period of time, but their liquid permeability suppression period is too short as a fluid control material for the work of a larger scale and a longer period of time. As a result of further study with the above-mentioned knowledge, the present inventors have had knowledge that it is desirable to use a polyglycolic acid resin of a larger molecular weight to extend the liquid permeability suppression period and to adjust the period of restoration of the suppressed liquid permeability by using particulate solid (fine particles or short fiber) in a smaller size of the polyglycolic acid resin, thereby arriving at the present invention. The fluid control material of a polyglycolic acid resin having the above-mentioned range of molecular weights used in the present invention generally has the following advantageous points compared with conventional fluid control materials comprising other aliphatic polyesters proposed hitherto.

(a) First, it provides a liquid permeability suppression period which is long enough at least in a low temperature region of 40-80° C. compared with the conventional polyglycolic acid resin having molecular weight of the oligomer range.
(b) Compared with other aliphatic polyesters, such as polylactic acid, it has an appropriate degree of hydrolysis rate even in low-temperature neutral water, and can therefore shorten the period required for restoring the suppressed liquid permeability. Moreover, although polycaprolactone (PCL) cannot maintain its particulate solid form but agglomerates during its decomposition, polyglycolic acid resin causes a weight loss (accordingly, a size reduction) while retaining the particulate solid form, so that the recovery of the liquid permeability becomes easy.
(c) Generally, aliphatic polyesters do not show good pulverizability. In order to use fine particles for shortening the period of recovering liquid permeability, a good pulverizability is generally preferred, polyglycolic acid resin of the molecular weight range used by the present invention shows a relatively good pulverizability at least under a low-temperature condition, compared with other aliphatic polyester, such as polylactic acid, and can provide the particles of a desired size with a higher yield

All the above-mentioned characteristics (a)-(c) are experimentally confirmed by comparison between Examples and Comparative Examples described hereinafter. Further, polyglycolic acid resin has a higher crystallinity than other aliphatic polyesters, and the pulverizability thereof can be further improved through addition of heat history during or after the production.

### BEST MODE FOR PRACTICING THE INVENTION

Hereinafter, the present invention will be described in further detail with reference to preferred embodiments.

### (Polyglycolic Acid Resin)

Polyglycolic acid resin used in the present invention may include glycolic acid homopolymer (namely, polyglycolic acid) consisting only of a glycolic acid unit (—OCH₂—CO—) as a recurring unit, and also a glycolic acid copolymer which includes hydroxyl carboxylic acid units, such as other monomer (comonomer) units, preferably lactic acid, in a proportion of at most 10 wt. %. The hydrolysis rate, crystallinity, etc., of polyglycolic acid resin can be modified to some extent by converting it into a copolymer including another monomer unit, but the above-mentioned excellent characteristics used in the present invention of the polyglycolic acid (resin), can be impaired if it contains more than 10 wt. % of such another monomer unit, so that it is not preferred.

Polyglycolic acid resin having a weight-average molecular weight of 70,000-500,000, is used. If the weight-average molecular weight is below 70,000, the hydrolyzability becomes excessive, and it becomes difficult to attain a liquid permeability suppression period required for the well drilling and fracturing work. On the other hand, if the weight-average molecular weight exceeds 500,000, the pulverizability becomes worse, and the molding or processability also becomes scarce, so that it becomes difficult to attain the advantage of higher molecular weight.

In order to obtain polyglycolic acid resin of such a large molecular weight, rather than polymerization of glycolic acid, it is preferred to adopt a process of subjecting glycolide which is a dimer of glycolic acid to ring-opening polymerization in the presence of a small amount of catalyst (cation catalyst, such as organo-tin carboxylate, tin halide, or antimony halide) and substantially in the absence of a solvent (namely, bulk polymerization conditions) under heating at temperatures of about 120-250° C. Accordingly, in case of forming a copolymer, it is preferred to use as a comonomer one or more species of lactides, as represented by lactide which is a dimer of lactic acid, and lactones (e.g., caprolactone, beta-propiolactone, beta-butyrolactone).

Incidentally, the melting point (Tm) of polyglycolic acid resin is generally 200° C. or higher. For example, polyglycolic acid has a melting point of about 220° C., a glass transition temperature of about 38° C., and a crystallization temperature of about 90° C. However, the melting point of the polyglycolic acid resin can vary to some extent depending on the molecular weight thereof, comonomer species, etc.

Although the particulate solid used as a fluid control material in the present invention, is usually composed of the polyglycolic acid resin alone, but it is also possible to blend other aliphatic polyesters (e.g., homopolymer or copolymer of comonomers for giving the glycolic acid copolymer described above) or a monomer of aliphatic polyesters including glycolic acid (or glycolide), for the purpose of controlling decomposability, pulverizability, etc. However, the blending amount thereof should be suppressed to less than 30 wt. %, preferably less than 20 wt. %, more preferably less than 10 wt. % of the polyglycolic acid resin, so as not to impair the above-mentioned excellent properties of the polyglycolic acid resin.

To the polyglycolic acid resin, it is further possible to add various additives, such as thermal stabilizer, light stabilizer, inorganic filler, plasticizer, desiccant, waterproofing agent, water repellent, and lubricant, as needed, within an extent not adverse to the object (particularly, decomposability and pulverizability) of the present invention.

The dispersion liquid for supporting oil drilling of the present invention contains the polyglycolic acid resin (or a composition including other optional components in some cases) obtained as described above in a particulate solid form capable of exhibiting appropriate degrees of weight retentivities in water at 80° C. The particulate solid may be primary solids, which include flakes after polymerization of polyglycolic acid resin (composition), and pellets having a uniform shape and prepared by various processes, such as hot cutting, strand cutting, underwater cutting, etc., after melting (and kneading) of the polymerizate, each having a size suitable for exhibiting the above-mentioned weight retentivities in water, for example those having a length in a longitudinal direction of 1-10 mm, and an aspect ratio of less than 5. The particulate solid may further include: particles, staple fiber, film pieces, etc., which are obtained by further shaping or processing of such primary solids.

For the conversion into particles, it is preferred to use high velocity revolution mills, such as a pin mill, a hammer mill, and a blade mill, or a jet mill, and a bead mill, capable of fine pulverization under cooling, e.g., by direct mixing of liquid nitrogen or dry ice. Further, in case where the polyglycolic acid resin has been subjected to a relatively prolonged heat treatment after its production, the polyglycolic acid resin can also be pulverized without using particular low-temperature conditions or under remarkably moderated cooling. The thus-obtained fine particles having a longer axis (L)/shorter axis (D) ratio of generally 1.9 or less and a cumulatively 50 wt. % diameter (D₅₀) (of which the measurement method will be described later) of 1-1000 μm, may be suitably used in the present invention.

As a particulate solid, it is also possible to use a short fiber having a length (L)/shorter axis (D) (cross-sectional diameter) ratio of 10-2000 and a shorter axis (D) of 5-95 μm which may be obtained by extruding a melt of polyglycolic acid resin (composition) through a short-diameter nozzle to form fiber and cutting the fiber, optionally after drawing the fiber.

Further, such a particulate solid can also be formed by cutting a sheet or film obtained by melt-extrusion shaping of the above-mentioned polyglycolic acid resin (composition), and film pieces having an area of 0.01-10 cm² and a thickness of 1-500 μm may also be suitably used.

Furthermore, in the present invention, it is possible to use the above-mentioned various shapes of particulate solid polyglycolic acid resin (composition) individually, but it is also possible to use two or more species of various forms and/or different sizes in combination of arbitrary ratios, thereby controlling weight retentivities in water and/or fluid suppression effects.

Generally, particles are suitable for mass production, and short fibers are preferably used for a polyglycolic acid resin having a somewhat lower pulverizability as a result of giving more priority to their decomposability, or in case where a higher uniformity of fluidity suppression effect is required. The thus-obtained particulate solids, inclusive of particles or short fibers may be adjusted to provided a desired liquid permeability recovery period, which is mainly governed by the value of shorter axis (D) and decomposability of the polyglycolic acid resin, within the requirement of the present invention of exhibiting weight retentivities in water at 80° C. of at least 85% after 12 hours, at most 80% after 72 hours, and at most 45% after 168 hours. The above-mentioned weight retentivities in water at 80° C. may correspond to weight retentivities in water at 40° C. of at least 85% after 72 hours, at most 80% after 1200 hours, and at most 45% after 3000 hours.

The dispersion liquid for supporting oil drilling of the present invention may be basically obtained by distributing a particulate solid of polyglycolic acid resin as described above in an aqueous medium. Herein, the aqueous medium refers to a liquid medium containing at least 10% of water. Depending on use, such a composition of aqueous medium can be formed in situ by intentionally introducing water after introducing particulate solid polyglycolic acid resin into the well. In the absence of water, the hydrolysis of polyglycolic acid resin does not proceed sufficiently, thus leading to inefficient recovery of liquid permeability.

As components other than water, it is possible to use aliphatic alcohols, such as methanol, ethanol and ethylene glycol; polyalcohols, such as polyglycerol; aliphatic alkane, such as hexane, heptane, and octane; ketones, such as acetone; ethers, such as diethyl ether; and polyethers, polyethylene glycol, from a viewpoint of dispersibility.

### (Other Fluid Control Materials)

Particulate solid polyglycolic acid resin used in the present invention is a fluid control material by itself which functions as a fluid suppression material and also as a fluid recovery material having self-decomposability in an aqueous medium. It is however an ordinary practice to use other fluid control materials together therewith depending on the geological nature of formation surrounding the objective well.

As such other fluid control materials, conventional various kinds of fluid control materials may also be used. Examples thereof may include: inorganic materials, inclusive of inorganic well wall and mud wall reinforcements, such as a gravel and calcium carbonate, collapse inhibitors, such as KCl, and specific gravity regulators, such as alkali metal halides, and alkaline earth metal halides (e.g., CaBr₂, CaCl₂); organic colloid agents (polymers) or organic well wall and mud wall reinforcements, such as guar gum, and further inorganic colloid agents (clays), dispersant or deflocculation agents, surfactants, mud-escape preventing materials, defoaming agents, corrosion inhibitors, etc. These fluid control materials may be contained in the dispersion liquid for supporting oil drilling at concentrations depending on their functions and objective formations.

### EXAMPLES

Hereinafter, the present invention will be described more specifically based on Examples and Comparative Examples. The characteristic values disclosed in this specification including Examples described later are based on values measured according to the following methods.

### <Weight-Average Molecular Weight (Mw)>

For measurement of the weight-average molecular weights (Mw) of the polyglycolic acid (PGA) and polylactic acid (PLA) as a starting material and in a particulate solid form, respectively, each sample of 10 mg was dissolved in hexafluoroisopropanol (HFIP) containing sodium trifluoroacetate dissolved therein at a concentration of 5 mM to form a solution in 10 mL, which was then filtered through a membrane filter to obtain a sample solution. The sample solution in 10 μL was injected into the gel permeation chromatography (GC) apparatus to measure the molecular weight under the following conditions. Incidentally, the sample solution was injected into the GPC apparatus within 30 minutes after the dissolution.

### <GC Conditions>

### Apparatus: Shimadzu LC-9A,

Column: HFIP-806M×(series connection)+Precolumn: HFIP-LG×1
Column temperature: 40° C.,
Elution liquid: An HFIP solution containing 5 mM of sodium trifluoroacetate dissolved therein
Flow rate: 1 mL/min.
Detector: Differential refractive index meter
Molecular-weight calibration: A calibration curve was prepared by using five standard molecular weight samples of polymethyl methacrylate having different molecular weights (made bym POLYMER LABORATORIES Ltd.) and used for determining the molecular weights.

### <Average Particle Size>

A PGA or PLA particle sample was dispersed in water containing a surfactant (“SN Dispersant 7347-c Diluted Solution”, made by Sannopco Co., Japan) to obtain a dispersion liquid, which was subjected to measurement of a particle size distribution by a laser diffraction type particle-size-distribution meter (“SALD-3000S” made by Shimadzu Corp.). Based on the acquired particle size distribution, an average particle size (D₅₀) was determined as a particle size at which an accumulated weight counted from a smaller diameter side (the same even counted from a larger diameter side) reached 50%.

### <Particle Preparation Method (Pulverization Method) and Pulverization Yield>

Pulverization method (1): About 20 kg of a primary solid-form polymer sample was immersed in liquid nitrogen to be cooled and then pulverized for 2 minutes under the conditions of a pulverization temperature of 7.5° C. and a revolving speed of 187 m/second by using a pin mill adapted to cooling with liquid nitrogen during pulverization (“Ultrafine Pulverization Pin Mill: Contraplex Series”, made by Makino Sangyo K.K.) under cooling with liquid nitrogen. The pulverizate was subjected to sieving with a screen having an opening of 106 μm (150 meshes) and particles having passed through the screen were recovered to calculate a weight percentage thereof with respect to the weight of the sample before the pulverization as a pulverization yield (%).

Pulverization method (2): About 40 g of a primary solid-form polymer sample was supplied together with dry ice of double weight to a hammer mill (“POLYMIX PX-MFC 90D”, made by KINEMATIC AG) and was pulverized for 1 minute at a speed of 6000 RPM. The pulverizate was subjected to sieving with a screen having an opening of 840 μm and particles having passed through the screen were recovered to calculate a weight percentage thereof with respect to the weight of the sample before the pulverization as a pulverization yield (%).

### <Short Fiber Preparation Method>

Polyglycolic acid (PGA) was melted at a resin temperature of 240-250° C. and extruded through a nozzle with 24 holes (hole diameter: 0.3 mm) at a rate of 0.51 g/hole, followed by cooling with air at about 5° C., to obtain undrawn yarn. Then, the undrawn yarn was drawn at 2.7 times at a temperature of 60° C. and heat-treated for 3 minutes at 100° C., to obtain drawn yarn with a cross-section of about 16 μm (fineness of 1.7 deniers). The drawn yarn was cut into about 5 mm in length to obtain PGA short fiber.

### <Weight Retentivity>

1 g of particulate solid-form polymer sample was dispersed in 50 mL of water in a glass bottle (“Threaded-mouth glass bottle SV-50”, made by Nichiden-Rika Glass Co., Ltd.) and stored in a thermostat vessel at 80° C. (or 40° C.) for a predetermined period. The content liquid in the glass bottle was then poured out on the filter paper and filtered by its weight, and the solid component having remained on the filter paper was left standing for one day at room temperature and then dried at 80° C. in an N₂ atmosphere. The weight of the dried solid polymer component measured to calculate a ratio thereof with respect to the weight of the polymer sample dispersed in the glass bottle as a weight retentivity (%) for each predetermined time. Incidentally, in case where an additional component, such as calcium carbonate or gravel, was used, the amount of the polymer on the filter paper was determined by subtracting the weight thereof, e.g., by dissolving away the calcium carbonate remaining on the filter paper with a sufficient amount of water or by deducting the amount of the gravel.

### Example 1

Cylindrical pellet-form glycolic acid (PGA) with a longer axis of about 3 mm and a cross-sectional diameter of about 3 mm (a weight-average molecular weight (Mw)=173,000, made by Kureha Corporation) was pulverized by Pulverization method 1 to recover a fraction passing through a screen having an opening of 106 μm as PGA particles (A). Three dispersion liquids in glass bottles each obtained by dispersing 1 g of PGA particles (A) in 50 mL of deionized water in the glass bottles were held in a thermostat at 80° C. for 12 hours, 72 hours and 168 hours, respectively, to measure the weight retentivities by the above-mentioned process based on the solid components having remained.

The outline of the above, and the measurement results of the pulverization yield and weight retentivities, are collectively shown in Table 1 together with the results of the following Examples and Comparative Examples.

### Example 2

The procedure of Example 1 was repeated except for using dispersion liquids obtained by dispersing 1 g each of PGA particles (A) obtained in Example 1 in 50 mL of 0.35 mol-NaCl aqueous solution in vial bottles, to determine the weight retentivities for respective predetermined periods of time.

### Example 3

The procedure of Example 1 was repeated except for using dispersion liquids obtained by dispersing 1 g each of PGA particles (A) obtained in Example 1 in 50 mL of 1.92 mol-NaCl aqueous solution in vial bottles, to determine the weight retentivities for respective predetermined periods of time.

### Example 4

The procedure of Example 1 was repeated except for using dispersion liquids obtained by dispersing 1 g each of PGA particles (A) obtained in Example 1 in 50 mL of 1.92 mol-KCl aqueous solution in vial bottles, to determine the weight retentivities for respective predetermined periods of time.

### Example 5

The procedure of Example 1 was repeated except for using dispersion liquids obtained by dispersing 1 g each of PGA particles (A) obtained in Example 1 in 50 mL of 1.92 mol-CaCl₂ aqueous solution in vial bottles, to determine the weight retentivities for respective predetermined periods of time.

### Example 6

The procedure of Example 1 was repeated except for using dispersion liquids obtained by dispersing 1 g each of PGA particles (A) obtained in Example 1 in 50 mL of 1.92 mol-CaCO₃ aqueous solution in vial bottles, to determine the weight retentivities for respective predetermined periods of time.

### Example 7

The procedure of Example 1 was repeated except for using dispersion liquids obtained by dispersing 1 g each of PGA particles (A) obtained in Example 1 and 0.3 g each of gravels (particle sizes of about 0.15-2.39 mm) in 50 mL of 1.92 mol-CaCl₂ aqueous solution in vial bottles, to determine the weight retentivities for respective predetermined periods of time.

### Example 8

Cylindrical pellet-form glycolic acid (PGA) with a longer axis of about 3 mm and a cross-sectional diameter of about 3 mm (a weight-average molecular weight (Mw)=250,000, made by Kureha Corporation) was pulverized by Pulverization method 1 to recover a fraction passing through a screen having an opening of 106 μm as PGA particles (B). The procedure of Example 1 was repeated except for using dispersion liquids obtained by using the PGA particles (B) instead of PGA particles (A), to determine the weight retentivities for respective predetermined periods of time.

### Example 9

Cylindrical pellet-form glycolic acid (PGA) with a longer axis of about 3 mm and a cross-sectional diameter of about 3 mm (a weight-average molecular weight (Mw)=85,000, made by Kureha Corporation) was pulverized by Pulverization method 1 to recover a fraction passing through a screen having an opening of 805 μm as PGA particles (C). The procedure of Example 1 was repeated except for using dispersion liquids obtained by using the PGA particles (C) instead of PGA particles (A), to determine the weight retentivities for respective predetermined periods of time.

### Example 10

PGA short fiber (D) was obtained by applying Short fiber preparation method described above to the pellet-form PGA used in Example 1. The procedure of Example 1 was repeated except for using dispersion liquids obtained by using the PGA short fiber (D) instead of PGA particles (A), to determine the weight retentivities for respective predetermined periods of time.

### Comparative Example 1

A 70% aqueous solution of glycolic acid (Industrial grade, made by E. I. du Pont de Nemours & Co.) was heated from room temperature to 220° C. in 24 hours. Thus, a condensation reaction was performed while distilling off resultant water during that period. Thereafter, the pressure was gradually lowered from normal pressure to 2 kPa in 1 hour and the system was further heated at 220° C. for 3 hours, to continue the condensation reaction, thereby obtaining an oligomer having a molecular weight of 28,000.

The thus-obtained oligomer was pulverized by Pulverization method 1 to recover a fraction passing through a screen having an opening of 106 μm as PGA (oligomer) particles. The procedure of Example 1 was repeated except for using dispersion liquids obtained by using the PGA (oligomer) particles instead of PGA particles (A), to determine the weight retentivities for respective predetermined periods of time.

### Comparative Example 2

Cylindrical pellet-form crystalline polylactic acid with a longer axis of about 3 mm and a cross-sectional diameter of about 3 mm (“7000D”, made by Nature Works LLC) was pulverized by Pulverization method 1 to recover a fraction passing through a screen having an opening of 106 μm as PLA particles (A). The procedure of Example 1 was repeated except for using dispersion liquids obtained by using the PLA particles (A) instead of PGA particles (A), to determine the weight retentivities for respective predetermined periods of time.

### Comparative Example 3

The pellet-form crystalline polylactic acid used in Comparative Example 2 was pulverized by Pulverization method 2 to recover a fraction passing through a screen having an opening of 840 μm as PLA particles (B). The procedure of Example 1 was repeated except for using dispersion liquids obtained by using the PLA particles (B) instead of PGA particles (A), to determine the weight retentivities for respective predetermined periods of time.

### Comparative Examples 4-9

Dispersion liquids were obtained in the same manner as in Examples 2-7, respectively, except for using the PLA particles (B) obtained in Comparative Example 3 instead of the PGA particles (A) used in Examples 2-7. These dispersion liquids were respectively used for determining the weight retentivities for respective predetermined periods of time in the same manner as in Examples 2-7.

The outlines of the above-mentioned Examples and Comparative Examples, and the measured pulverization yields and weight retentivities (at 80° C. and also at 40° C. for some Examples and Comparative Examples), are inclusively shown in the following Table 1.

[symbol]

### INDUSTRIAL APPLICABILITY

As is understood from the results shown in the above Table 1, in the dispersion liquid for supporting oil drilling of the present invention, the particulate solid polyglycolic acid resin of a large molecular weight used as a fluidity control material, shows ideal fluid control characteristics in the drilling operation and fracturing operation, inclusive of a large weight retentivity in water at 80° C. after 12 hours required for providing a suppressed liquid permeability in an early stage and also sufficiently small weight retentivities in water at 80° C. after 72 hours and 168 hours required for recovery of liquid fluidity after completion of the operations. Moreover, it is also understood that the polyglycolic acid resin shows a remarkably higher pulverizability required for providing particle sizes suitable as a fluidity control material than polylactic acid.

1-14. (canceled)

15. A process for producing a dispersion liquid for supporting oil drilling, comprising:
pulverizing a primary solid-form polyglycolic acid resin having a weight-average molecular weight of at least 70,000 and at most 500,000 under cooling at a reduced temperature (below room temperature) to form a particulate solid polyglycolic acid resin which comprises fine powders having a cumulatively 50 wt. % diameter (D₅₀) of 1-1000 μm and exhibits weight retentivities in (neat) water at 80° C. of at least 85% after 12 hours, at most 80% after 72 hours, and at most 45% after 168 hours; and
dispersing the particulate solid polyglycolic acid resin in an aqueous dispersion medium.

16. The process according to claim 15, wherein the primary solid-form polyglycolic acid resin is pulverized under cooling with liquid nitrogen.

17. The process according to claim 15, wherein the primary solid-form polyglycolic acid resin is pulverized under cooling with dry ice.

18. The process according to claim 15, wherein the primary solid-form polyglycolic acid resin is heat-treated (for crystallization) prior to the pulverization.

19. The process according to claim 15, wherein the polyglycolic acid resin is glycolic acid homopolymer.

20. The process according to claim 15, wherein the particulate polyglycolic acid resin exhibits weight retentivities in (neat) water at 40° C. of at least 85% after 72 hours, at most 80% after 1200 hours, and at most 45% after 3000 hours.

21. The process according to claim 15, wherein the particulate solid polyglycolic acid resin comprises fine powders having a cumulatively 50 wt. % diameter (D₅₀) of 87-450 μm.
